(19) United States
(12) Patent Application Publication
(10) Pub. No.: US 2008/0068145 A1
(43) Pub. Date: Mar. 20, 2008

(54) Motor Vehicle With A Sensor Arrangement

(75) Inventors: Ludger Weghaus, Lippstadt (DE); Joachim Olk, Lippstadt (DE); Bernhard Marx, Geseke (DE)

Correspondence Address: HUSCH & EPPENBERGER, LLC, 190 CARONDELET PLAZA, SUITE 600, ST. LOUIS, MO, 63105-3441, US

(73) Assignee: Hella KGaA, Lippstadt (DE)

(21) Appl. No.: 11/857,863

(22) Filed: Sep. 19, 2007

(30) Foreign Application Priority Data
Sep. 20, 2006 (DE) 10 2006 044 112.5

(51) Int. Cl. B60R 25/00

(52) U.S. Cl. 340/426.25; 340/426.28; 340/426.36

(57) ABSTRACT

A motor vehicle with a sensor arrangement for monitoring some of the outside area around the motor vehicle for the presence of a user's limb or part of an object, where the sensor arrangement is installed and aligned such that a simple movement of the body, e.g. lifting and/or turning the leg or foot, is enough to move some of a leg or foot of a user standing next to the motor vehicle into the part of the outside area around the motor vehicle monitored by the sensor arrangement.

### CROSS-REFERENCE TO RELATED APPLICATIONS

This application claims priority to international application DE 10 2006 044 112.5 filed on Sep. 20, 2006.

### BACKGROUND OF THE INVENTION

1. Field of the Invention

The subject matter of the invention is a motor vehicle with a sensor arrangement for monitoring some of the outside area around the motor vehicle for the presence of a user's limb or part of an object.

2. Summary of the Invention

Publication DE 10 2004 055 982 A1 describes the use of an ultrasound sensor installed in the vicinity of the license plate lighting. The sensor is arranged such that the ultrasound beam mainly goes vertically down from the top. This orientation of the sensor is chosen for the reason of avoiding or reducing the amount of dirt on the sensor as caused by rain or snow, for example. The ultrasound sensor belongs to a locking system for a vehicle where the locking system includes a control unit which can be used to actuate locking elements for unlocking, locking, opening, closing and/or activating or deactivating implements for opening the vehicle. Locking elements of the locking system will be actuated depending on whether or not an object or part of the body, for example a hand, is moved within or into the detection range of the sensor. The part of the body moved into the detection range of the sensor would be normally a hand because the sensor resides on the motor vehicle at a height that would make operation by foot or similar less than optimal.

However, using your hands to actuate or release the locking elements for unlocking or locking or opening or closing a trunk lid is a disadvantage whenever the operator is holding one or several objects in their hands that they wish to put into or remove from the trunk. To be able to move a hand into the detection range, the operator would have to free one hand.

The same applies to opening and closing sliding doors, for example.

Starting out from the disadvantage of the state-of-the-art solution, the task of the invention is to make it more convenient to open doors, hoods or lids of motor vehicles.

The invention suggests solving the problem by mounting and aligning the sensor installation such that a simple movement of the body, e.g. lifting and/or turning the leg or foot, is enough to move some of a leg or foot of a user standing next to the motor vehicle into the part of the outside area around the motor vehicle monitored by the sensor arrangement. Standing next to the vehicle means both a user standing on the side next to the motor vehicle and a user standing in front or behind the motor vehicle.

The invention would benefit from the motor vehicle having a configuration for keyless control of a user's access and driving permission. Such configurations are state of the art and sometimes called “passive entry/go” or “keyless entry/keyless go” systems.

A motor vehicle in accordance with the invention could provide motor-driven means of unlocking and/or locking a door, hood or lid. Such means are normally part of a configuration for keyless control of access and/or driving permission.

A motor vehicle in accordance with the invention could provide motor-driven means of opening and/or closing a door, hood or lid.

A motor vehicle in accordance with the invention could provide a means of control which should preferably interlink with the sensor arrangement. The sensor arrangement of a motor vehicle according to the invention can be capable of and set up for transmitting a signal to the means of control whenever the sensor arrangement detects an object of limb being moved into the part of the outside area around the motor vehicle monitored by the sensor arrangement. The means of control of a motor vehicle according to the invention can be capable of and set up for activating and/or deactivating the means of unlocking and/or locking following a signal received from the sensor arrangement. Such signals can be received by the means of control from other or further sensor arrangements.

The means of control of a motor vehicle in accordance with the invention can be capable of and set up for activating and/or deactivating the means of opening and/or closing following a signal received from the sensor arrangement.

A motor vehicle in accordance with the invention can provide motor-driven means of folding in and/or out a swiveling trailer hitch. The means of control of a motor vehicle in accordance with the invention can be capable of and set up for activating and/or deactivating the means of folding in and/or out the trailer hitch following a signal received from the sensor arrangement.

The sensor arrangement is preferably located near a door, hood or lid of the motor vehicle. There may be multiple sensor arrangements, where every sensor arrangement is allocated to a door, hood or lid.

A sensor arrangement that is allocated to a bonnet or trunk lid would very much benefit from being located somewhere along the rear end of the motor vehicle. Specifically, it could be located above a bottom edge of a bumper.

The part of the outside area around the motor vehicle monitored by the sensor arrangement can be marked either directly on the actual motor vehicle or on its body or by a means of marking which could generate a light dot on the ground, for example. The part of the outside area around the motor vehicle monitored by the sensor arrangement can be located underneath the outer shell of the motor vehicle.

The sensor arrangement may include a motion detector of any type. The sensor can be a capacitive sensor, an infrared sensor or another optical type of sensor or an ultrasound sensor.

A method of opening a door, hood and/or lid of a motor vehicle according to the invention could be designed such that, after a user has been authenticated by an ID transmitter and, thus, the user's authorization has been verified, the means of unlocking are activated. Following unlock, the means of control can activate the means of opening without requiring further user action or an object or limb being moved into the part of the outside area around the motor vehicle monitored by the sensor arrangement.

According to the invention, a method of opening a door, hood and/or lid of a motor vehicle could be designed such that, after a user has been authenticated by an ID transmitter and, thus, the user's authorization has been verified, the means of locking are activated.

Before locking, the means of control can activate the means of closing open doors, hoods or lids by moving an object or limb into the part of the outside area around the motor vehicle monitored by the sensor arrangement.

Authentication can be provided by moving an object or limb into the part of the outside area around the motor vehicle monitored by the sensor arrangement. Prior to locking, all doors, hoods and/or lids that are at least partially open can activate the means of locking.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

The drawings illustrate the example design of a motor vehicle according to the invention. The following is shown:

FIG. 1 is a block diagram of the present invention, and

FIG. 2 is a schematic view of the rear end of a motor vehicle.

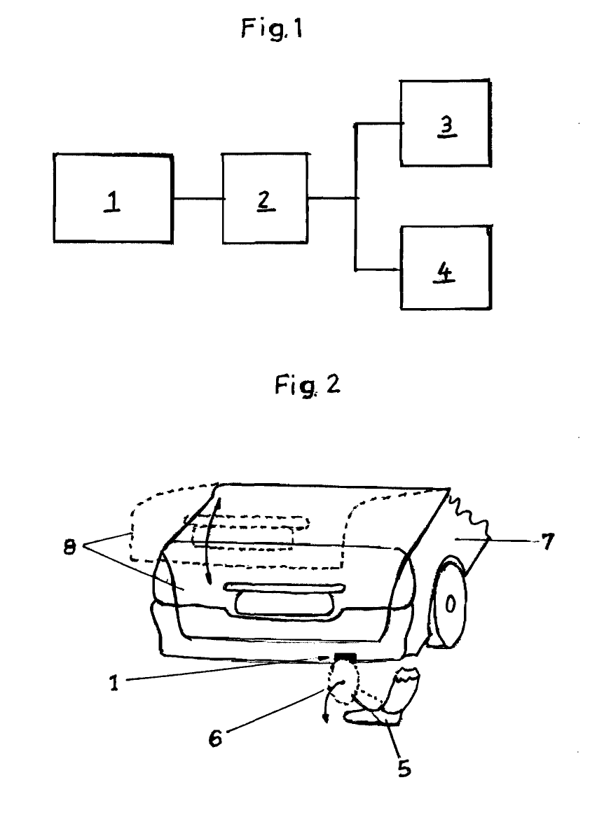

### DETAILED DESCRIPTION OF THE PREFERRED EMBODIMENTS

The following description of the preferred embodiment(s) is merely exemplary in nature and is in no way intended to limit the invention, its application, or uses.

A motor vehicle 7 in accordance with the invention (FIG. 2) has a sensor arrangement 1 with a capacitive sensor located somewhere along the rear bumper. The sensor arrangement 1 is mounted to the rear end of the vehicle 7 such that the detection range 6 of the capacitive sensor faces down. The detection range 6 of the sensor or the sensor arrangement 1 monitors some of the outside area around the motor vehicle 7. Making the detection range 6 of the sensor arrangement 1 face down allows a simple move of the body of a user standing behind the motor vehicle 7 to move their foot 5 into the detection range 6, i.e., towards the part 6 of the outside area around the motor vehicle 7 monitored by the sensor arrangement 1. Moving the foot into the detection range 6 of a motor vehicle 7 in accordance with the invention can generate a signal for opening the trunk lid 8.

The sensor arrangement 1 is connected to a means of control 2 of the motor vehicle 7. When an object or limb moves into the detection range 6 of the sensor arrangement 1, the sensor arrangement 1 will transmit a signal to the means of control 2. The means of control 2 is further connected to means 3 of unlocking and locking the motor vehicle and to means 4 of opening and closing doors, hoods and lids 8. Both types of means, i.e. 3 and 4, can be activated or deactivated by the means of control 2.

According to the invention, a motor vehicle 7 can be used as follows to open or close the trunk lid 8, for example.

A user wishing to open the trunk lid 8 approaches the motor vehicle 7. By moving the foot 5 into the detection range 6 of the sensor installation 1, the user will provoke a signal that the sensor arrangement 1 will transmit to the means of control 2. The user is authenticated in a usual manner through an ID transmitter carried by the user. The means of control 2 will then activate the means 3 for unlocking the trunk lid 8. The user could now open the trunk lid by hand. However, immediately after activating the means 3 for unlocking the trunk lid 8, the means of control 2 will activate the means 4 for opening the trunk lid 8. These means 4 include a drive which moves the trunk lid to an open position. The user, therefore, does not need to use their hands to open the trunk lid 8. The user can thus carry one or several objects in both hands without having to put them down before they are able to open the trunk lid 8. Instead, the user can immediately put the objects into the trunk when the trunk lid 8 has opened automatically.

Reference Items

1 Sensor arrangement

2 Means of control

3 Means of unlocking and locking

4 Means of opening and closing

5 Foot

6 Detection range

7 Motor vehicle

8 Trunk lid

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A motor vehicle sensor arranged for monitoring an outside area around the motor vehicle for the presence of a user's limb or an object, comprising:
a sensor, said sensor being mounted on said vehicle to sense an area adjacent the vehicle and aligned such that a movement of a user's body standing next to the motor vehicle into said sensed area around the motor vehicle, generates a signal from said sensor to an actuator in the vehicle in operative communication with said sensor.

2. The motor vehicle sensor as in claim 1, wherein the motor vehicle includes configuration for keyless control of a user's authorization to access and/or drive the motor vehicle.

3. The motor vehicle sensor as in claim 1, wherein the motor vehicle has motor-driven actuator deployed to unlock and/or lock a door, hood or lid.

4. The motor vehicle sensor as in claim 1, wherein the motor vehicle has motor-driven actuator deployed to open and/or close a door, hood or lid of the motor vehicle.

5. The motor vehicle sensor as in claim 1, further comprises a controller, said controller being in operative communication with said sensor.

6. The motor vehicle sensor as in claim 5, wherein the sensor signals to said controller whenever the sensor detects an object or limb moving into the part of the said area adjacent the vehicle monitored by the sensor.

7. The motor vehicle sensor as in claim 5, wherein the controller unlocks and/or locks a door, hood or lid when it receives a signal from the sensor.

8. The motor vehicle sensor as in claim 5, wherein the controller activates and/or deactivates an actuator for opening and/or closing in response to a signal from the sensor.

9. The motor vehicle sensor as in claim 1, wherein the motor vehicle has motor deployed to fold in and/or out a swiveling trailer hitch.

10. The motor vehicle sensor as in claim 9, wherein the controller activates and/or deactivates an actuator for folding in and/or out when it receives a signal from the sensor.

11. The motor vehicle sensor as in claim 1, wherein the sensor is installed proximate to a door, hood or lid of the motor vehicle.

12. The motor vehicle sensor as in claim 1, wherein the sensor is installed at the rear end of the motor vehicle.

13. The motor vehicle sensor as in claim 1, wherein the sensor is installed above a bottom edge of a bumper.

14. The motor vehicle sensor as in claim 1, wherein the area adjacent the motor vehicle monitored by the sensor is marked on the motor vehicle.

15. The motor vehicle sensor as in claim 1, wherein the area adjacent the motor vehicle monitored by the sensor is located under an outer shell of the motor vehicle.

16. The motor vehicle sensor as in claim 1, wherein the sensor includes a motion detector.

17. The motor vehicle sensor as in claim 1, wherein the sensor arrangement includes a capacitive sensor.

18. The motor vehicle sensor as in claim 1, wherein the sensor includes an infrared sensor.

19. The motor vehicle sensor as in claim 1, wherein the sensor includes an ultrasound sensor.

20. The motor vehicle sensor as in claim 1, wherein said sensor transmits a signal in response to a defined motion profile or sequence of movements of the leg or foot.

21. A method of enabling opening a door, hood and/or lid of a motor vehicle comprising:
mounting a sensor to sense an area adjacent the vehicle connecting said sensor to an actuator, said actuator being deployed to actuate a door, hood, lock or lid in response to a signal from said sensor,
said sensor signaling said actuator in response to a movement in said area adjacent the vehicle,
wherein unlocking is activated when a user has been successfully authenticated by an ID transmitter.

22. The method as in claim 21, wherein the process of authentication is started by a movement into the area adjacent the motor vehicle monitored by the sensor.

23. The method of claim 22 wherein said movement is a sequence of motions by a user.

24. The method as in claim 22, wherein an at least partially open door, hood or lid activates closing prior to locking.

25. A motor vehicle having a sensor comprising:
a sensor, said sensor being mounted on said vehicle to sense an area adjacent the vehicle and aligned such that a movement of a user's body standing next to the motor vehicle into said sensed area around the motor vehicle, generates a signal from said sensor to an actuator in the vehicle in operative communication with said sensor.
